(19) United States
(12) Patent Application Publication
(10) Pub. No.: US 2008/0251194 A1
(43) Pub. Date: Oct. 16, 2008

(54) SLEEVE-SHAPED LABELS

(76) Inventors: Thomas Moeller, Duesseldorf (DE); Stefan Strenger, Essen (DE); Holger Toenniessen, Niederzier (DE)

Correspondence Address: HENKEL CORPORATION, 1001 TROUT BROOK CROSSING, ROCKY HILL, CT, 06067, US

(21) Appl. No.: 12/101,199

(22) Filed: Apr. 11, 2008

Related U.S. Application Data
(63) Continuation of application No. PCT/EP2006/007449, filed on Jul. 27, 2006.

(30) Foreign Application Priority Data
Oct. 14, 2005 (DE) 102005049681.4

(51) Int. Cl. B32B 37/28

(52) U.S. Cl. 156/275.3

(57) ABSTRACT

The invention relates to a method of producing sleeve-shaped, shrinkable or elastic labels from a film by bonding of the longitudinal edges. In this method the seam is bonded using a solvent-free adhesive which is crosslinked through a chemical reaction after application.

### CROSS-REFERENCE TO RELATED APPLICATIONS

This application is a continuation under 35 USC Sections 365(c) and 120 of International Application No. PCT/EP2006/007449, filed 27 Jul. 2006 and published 19 Apr. 2007 as WO 2007/042092, which claims priority from German Application No. 102005049681.4, filed 14 Oct. 2005, each of which is incorporated herein by reference in its entirety.

### FIELD OF THE INVENTION

The invention relates to a method of producing sleeve labels wherein an unprinted or printed film is adhered with the long sides to one another using a reactive adhesive. Sleeve labels of this kind are suitable as stretchable labels or shrinkable labels, as wrap-around labels, such as for bottles or multiangular packaging forms, for example. The invention further relates to sleeve labels where the seam of the labels is bonded with a reactive adhesive.

### DISCUSSION OF THE RELATED ART

It is known that articles are provided with labels: for example, bottles are provided with labels of different shapes. It is likewise known to adhere such labels not to the surface of the article, but instead also to use wrap-around labels. Such wrap-around labels are frequently applied by providing a prefabricated flat label with an adhesive along one edge, then applying that side to bottles, for example, and placing the label all around the bottle by rotation. A layer of adhesive is then likewise applied to the opposite edge, and is bonded in overlap to the label.

Moreover, there are machines and methods known for applying wrap-around labels in the form of a sleeve to rotationally symmetric articles. The labels in question are annular labels comprising one or two or more colaminated films which are brought to a circumference greater than the article to be labeled, are slipped over that article, and are subsequently applied to the surface of the article by elastic recovery (stretch labels) or by thermal shrinking (shrink-on labels). It is also known that shrinkable sleeve labels of this kind can also be used as a securement for screw closures on bottles.

JP 61244731 describes a method wherein a continuous strip of shrinkable polypropylene film is printed and at the same time a hot melt adhesive is applied to certain locations. The strip is slit to an appropriate length and the individual sections are brought together in the form of a sleeve and joined by heating. Thereafter these sleeves can be shrunk onto the corresponding bottles. No precise characterization of the adhesives is given. JP 07088958 describes a method in which a polyolefin film is printed, if desired, and is bonded with electron-beam-curing adhesives in the form of a tube. No further details of the adhesive are given. The tube materials are rolled up.

JP 2000043156 describes a method in which a primer is applied to the longitudinal edge of a polyethylene film, followed by a cyanoacrylate adhesive. The longitudinal edges are brought together and bonded. The corresponding film has elastic properties. JP 2002086572 describes a method in which labels are produced by bringing together opposite sides of a polymeric film, the two sides being bonded together with a solvent which comprises a fluorescent agent. The resulting label sleeves are made of shrinkable material.

U.S. Pat. No. 6,042,907 describes a method of producing wrap-around labels wherein a film of two different materials is produced and the side edges of the labels are bonded together on the substrate using a hotmelt adhesive. No further description of the hotmelt adhesive is given. EP 0688720 describes a method wherein a continuous film material comprising a shrinkable film is bonded using a solvent-based adhesive, adhesive being applied to the inside surface to produce a tubular label. This label is heat-shrinkable. The embodiment of the adhesive is not described in any closer detail.

The methods described of joining side edges of shrinkable or stretchable films have various disadvantages. Where the joining of the two edges is brought about by means of heat, such as by melting on, for example, the shrinkage properties of the longitudinal seam are different from those of the rest of the film. The use as an adhesive of solvents which cause swelling of the film material and in that way join both layers to one another is to be avoided on grounds of health protection. In both cases, furthermore, the visual appearance of the joint seam is distinctly different from the label, and frequently forms a bead. For hot melt adhesives it is general knowledge that they lose adhesion/cohesion on heating. Consequently, labels bonded in this way are frequently not shrinkable, since in the course of the shrinking operation, under heating, shearing forces act on the bond seam, which loses its stability and slips or opens. It is also possible for any included air bubbles to give rise to slipping of the bond seam. The dispensing of hot contents into vessels provided in this way with labels may also have an adverse effect on a thermoplastic bond seam.

### BRIEF SUMMARY OF THE INVENTION

It is therefore an object of the present invention to provide a method of producing wrap-around labels from films wherein a film is joined at the longitudinal seam using a reactive adhesive, this adhesive having good cohesion and adhesion properties, and the corresponding label can be slipped over the article, as an elastically stretchable label, or applied to the article by shrink application under heating, as a shrinkable label. The method is suitable more particularly for converting the labels directly, in a continuous operation, after bonding, and applying them to the articles.

The object is achieved by means of a method of continuously producing film tubes for producing sleeve labels, which comprises coating a single-layer or multilayer film which is elastically stretchable or heat-shrinkable with a solvent-free adhesive at one longitudinal edge on one side or on both longitudinal edges on opposite sides of the film, thereafter bringing the two longitudinal edges onto one another with the adhesive layer, in overlap with one another, and bonding them, being able to process the resulting film tube further immediately or after storage, the adhesive being selected from adhesives which crosslink through actinic radiation or adhesives which crosslink through polycondensation of reactive groups.

The invention further provides sleeve labels produced from film tubes of single-layer or multilayer, elastically stretchable or heat-shrinkable films which have been coated along one longitudinal edge or along both opposite longitudinally edges on one side or opposite sides of the film with any adhesive that crosslinks either through actinic radiation or through reactive groups, and have been bonded in overlap at the longitudinal edges on the surface of the adhesive layer.

### DETAILED DESCRIPTION OF CERTAIN EMBODIMENTS OF THE INVENTION

The method of the invention employs films which are known in principle, which are already used in the production of sleevelike wrap-around labels. Such labels may be composed, for example, of one or of two or more layers. These layers may be transparent, printed or else colored. In the context of the corresponding labels there are two different application methods to be distinguished. The wrap-around labels may be composed of elastic, stretchable film material. In that case the label is stretched and in the stretched state is placed over the article, and the stretching force is removed. As a result of the recovery force of the film, the sleeve of the label contracts and then sits firmly on the article to be labeled. A further method of application operates with shrink-on films. In this case the film is produced from a heat-shrinkable material. This material is brought into a sleeve form. The diameter of the wrap-around label is slightly greater than the article to be labeled. The label is pushed over the article and immediately thereafter is heat-shrunk. The film material contracts and bears tightly against the surface of the article. In this case it is also possible to mask irregular contours of an article.

Film materials for producing sleeve labels of this kind are known. They include, for example, films of polyolefins, such as polyethylene (PE) or polypropylene (PP), polyvinyl chloride (PVC), polystyrene (PS) or polyesters, such as PET. These film materials may also have been modified, by a modification of the polymers with functional groups, for example, or else it is possible for additional components, pigments or other polymers, for example, to be present in the film. The films may be colored, printed or colorless, and it is possible to use single-layer or multilayer films. If such films are shrinkable, they are generally films which have undergone unidirectional or bidirectional orientation. Methods of producing such films are common knowledge; methods of producing multilayer films or of printing such films have also been described.

The inventive procedure starts from known film materials as an intermediate. Such films are produced in webs and where appropriate are printed in accordance with the intended use. It may where appropriate be necessary to pretreat the films on the surface to be bonded, by means of a corona treatment, for example; typically, however, printed films can be directly processed further. In accordance with the method of the invention, a primer is not necessary before the application of the adhesive, and should be avoided. It should, however, be ensured that the surface of the bond seam does not have any substances which adversely affect the adhesion of the adhesives to the substrate. The surface to be bonded is preferably unprinted.

In one preferred embodiment a film web is bonded immediately after printing, to give a tube form. In this case an adhesive suitable in accordance with the invention is applied in the form of a stripe to one longitudinal edge of the film. The width of the stripe of adhesive can be between 1 mm to 20 mm, preferably 2 mm to 10 mm. It must be sufficient for a secure bond. In this case it is generally sufficient for the adhesive to be applied along one edge of the film; it is possible, however, for an adhesive to be applied to both edges on different sides of the film, and so the two coated stripes can be placed over one another. The thus-coated longitudinal edges of the film are brought together in overlap, immediately after coating with the adhesive, to form a bond seam, and are bonded to one another to form a tube.

The bonding may be assisted by a variety of measures. For instance, the bonded surfaces may be joined to one another by means of pressure, such as by means of press rollers, for example. A further possibility is to accelerate bonding by heating. In that case it must be ensured that heating is not accompanied by thermal damage to the film. Heating ought to take place such that temperatures are below the temperature needed for shrinking, or below a temperature at which damage occurs to the film, in the form of discoloration, for example. It is likewise beneficial, when using adhesives which crosslink through actinic radiation, to irradiate them immediately after the bond seam has been joined.

The film tube formed in this way can preferably be processed further immediately, by slitting, for example, into an appropriate size for sleeve labels, or else it is stored in a suitable form—wound up, for example. If the film tube is processed further immediately, the adhesives to be selected are to be such that after just a short time they have sufficient bond strength for the application method of the sleeve labels; in other words, the bond seam must withstand stretching of the label without alteration, or it must resist the heat exposure associated with shrinking, again without alteration. If the film tube is stored, it is possible to select adhesives which require a certain time for aftercure in order to develop their full bond strength. In the case of storage of the film tube, by winding, for example, care should be taken to ensure that the tube does not stick to itself and that it can be separated before further processing.

In accordance with the invention the adhesives are selected from the group of reactive solvent-free adhesives. They may be adhesives which crosslink through actinic radiation or adhesives which crosslink through other reactive groups. They may be 1-component systems or else 2-component systems, and may be room-temperature-crosslinking systems or systems which crosslink through temperature increase. They may be aqueous or solvent-free adhesives; where appropriate it is also possible to use solvent-containing adhesives, provided the solvents do not cause the films to swell. Particular preference is given to solvent-free adhesives, more particularly reactive, hot melt adhesives, more especially radiation-curing hot melt adhesives.

Examples of suitable adhesives are radiation-crosslinkable adhesives which can crosslink through free-radical or cationic polymerization. Adhesives of this kind may be of low viscosity, as in accordance with EP 1042422, for example; they are hot melt adhesives which crosslink through radiation, as described in WO 2004/013244, or they are known adhesives based on esters of (meth)acrylic acid, as mentioned in U.S. Pat. No. 5,128,386, U.S. Pat. No. 5,294,688, DE 10105278 or DE 10310889. It is also possible to use adhesives which feature two different crosslinking mechanisms, e.g., radiation curing and crosslinking via NCO groups, as are described, for example, in WO 01/12691.

Free-radically crosslinkable adhesives comprise, for example, polymers or oligomers which contain olefinically unsaturated groups. The groups in question may for example be unsaturated carboxylic acid groups, such as acrylate, methacrylate, maleic acid or maleimide groups or else may be vinyl ester groups, which may be present in polymers based on polyvinyl acetate, polyvinylidene chloride, alkyl, cycloalkyl or aryl esters of poly(meth)acrylic acid, (meth)acrylic acid homopolymers and/or copolymers, polyesters with aromatic and/or aliphatic carboxylic acids, polyethers, polycarbonates, polyacetals, polyurethanes, polyolefins, vinyl copolymers or rubber polymers such as nitrile, isoprene, chloroprene, diblock or multiblock copolymers of styrene with butadiene and/or isoprene and also their hydrogenated versions, such as SB, SBS, SI, SIS, SEPS, SEEPS, SIPS or SEBS rubber, for example. The arrangement of the polymer blocks in these cases may be either linear or radial. These polymers can be crosslinked where appropriate with or without additional photoinitiator.

Cationically crosslinkable adhesives may comprise, for example, polymers based on epoxidized polyolefins, as described for example in U.S. Pat. No. 5,229,464, WO 9828338 or U.S. Pat. No. 6,541,575, or polyester-, polyacrylate- or polyurethane-based polymers with glycidyl groups attached via reactive groups. Where appropriate these adhesives may also comprise low molecular mass oligomers which contain reactive groups that are able to react with the epoxy groups of the base polymers. The epoxy groups may be obtained by epoxidation of double bonds, or other functional groups of the starting polymers, OH groups for example, are reacted with suitable compounds containing glycidyl groups. Further suitable groups for cationic crosslinking are vinyl ethers or oxetane groups. Cationically or free-radically crosslinking systems ought more particularly to be UV-crosslinking and in that case generally comprise at least one initiator for the polymerization.

In the case of adhesives of low viscosity it is also possible for other components to be present, examples being additives, adhesion promoters, reactive diluents, stabilizers or wetting agents. The adhesive is preferably free from organic solvents. In the preferred case of radiation-curing hot melt adhesives, the adhesive comprises further components as well, such as a tackifying resin, for example, and also, where appropriate, further auxiliaries such as plasticizers, waxes, stabilizers, adhesion promoters or other additives.

The molecular weight of the polymers is dependent on the form of application. In the case of low-viscosity adhesives it can be between 500 up to 20,000 g/mol; in the case of hot melt adhesives, 2000 up to 100,000 g/mol (determined by GPC).

Adhesives which crosslink on the basis of polycondensation or polyaddition of functional groups are likewise known. These adhesives are described for example in EP 1045886. The binders in question may be binders with functional groups, such as epoxide groups, isocyanate groups or cyclic carbonate groups, for example. These are able to react with a second component which carries suitable reactive groups, the reaction in question preferably being a polycondensation or polyaddition. Examples of such groups are primary or secondary amino groups, OH groups, SH groups, carboxyl groups or phenol groups. It is possible for there to be 2-component systems present, i.e., the two components are not mixed until before application, and reactivity exists typically even at a low temperature. Also possible, however, are 1-component systems, where the crosslinking reaction is initiated only at an elevated temperature. It is possible for two different crosslinking mechanisms to be present simultaneously; including, for example, crosslinking of isocyanate groups via OH groups of polyols or via atmospheric moisture. It is possible to use adhesives which comprise initiators based on organoborane derivatives, as described for example in U.S. Pat. No. 5,296,433, U.S. Pat. No. 6,479,602 or U.S. Pat. No. 6 844 080.

Suitable binders, such as epoxy resins, polyurethane prepolymers, and polycarbonate binders, are known in wide ranges to the skilled worker. Also known are crosslinking components such as polyols based on polyethers, polyesters, polyacrylates, and polyurethanes; polyamines with secondary or primary amino groups with an aliphatic, aromatic, cycloaliphatic or polyether-based backbone; polyesters or polyacrylates containing free carboxyl groups. The adhesives may comprise the typical additives and auxiliaries, such as water, stabilizers, catalysts, adhesion promoters, viscosity regulators, reactive diluents, resins, tacky components, solvents where appropriate, plasticizers and/or waxes.

In the case of 2-part adhesives it is also possible to apply each component to one side of the bond area and to accomplish mixing by bringing the areas together. Particular preference, however, is given to reactive 1-part hot melt adhesives based on reactive polyurethanes, or to UV-crosslinking hot melt adhesives.

The selection of the adhesives ought to be matched to the film that is to be bonded. In this context it should be ensured that sufficient adhesion to the surface is built up. More particularly there ought to be a rapid initial adhesion. If the film tube is processed further directly, the development of adhesion by the adhesive must be almost completely at an end before the film is put on over the article. Where the bonded film tube or the converted label is stored, the ultimate adhesion may also be built up during a subsequent reaction time of more than 24 hours. At the time the label is applied, the shear strength of the bond, measured as the tensile strength at 25° C., ought to be above 25 N/12.5 mm, more particularly above 40 N/12.5 mm.

In the preferred form of immediate (in-line) processing the necessary adhesion ought to be developed within a time of 1 sec up to 5 min, more particularly from 3 sec up to 3 min, in particular from 10 sec up to 1 min. As a test of sufficient adhesion, a label produced in accordance with the invention is passed over a round article, a can for example, and is immediately attached, by being shrunk on, for example. Thereafter the can is stored at 120° C. and, after a test time of at least 5 minutes, the bond seam should not have slipped, opened or parted at the edges.

The production of the film tube is carried out with machines that are known in principle and which apply the adhesive to the margin of the film using segments, rolls or nozzles. This may take place, for example, by means of spraying, knifecoating, printing or roller application. The mode of application is also dependent on the viscosity of the adhesive. Where, for example, application is to take place by spraying, the adhesive must have a low viscosity. Where application is carried out using a die or in a curtain coating method, the viscosity may be higher. The viscosity of the adhesive may be influenced by the application temperature. In order to obtain a low viscosity, which is generally desired, the adhesive may be applied at an elevated temperature. In that case the temperature of the adhesive when it hits the film ought not adversely to affect said film.

The adhesives which can be used in accordance with the invention have the necessary low viscosity at low processing temperatures, as is desired, for example, in the context of their use on temperature-sensitive labels. The processing temperatures are in the range from 20° C. to 200° C., more particularly below 150° C., preferably in the range from 30° C. to 80° C. in the case of liquid adhesives, and preferably in the range from 80° C. to 130° C. when using hot melt adhesives. At the same time the low viscosity ensures clean running of machinery on the commercially customary machines.

For trouble-free processing the adhesives that are suitable in accordance with the invention ought to have a correspondingly low viscosity, which is dependent on the application method. In the case of application by a curtain coating method, the viscosity on exit from the slot die may where appropriate be up to 100,000 mPas; at the application temperature for other preferred methods of application, it is typically 100 mPas to 7500 mPas. For certain processing methods a viscosity below 4500 mPas, in particular down to 2500 mPas, is particularly suitable; more particularly the range is 200 mPas to 1000 mPas, measured with a Brookfield RVT, spindle 27. In the preferred case of hot melt adhesives, this viscosity ought to be obtained at temperatures up to 130° C.

Where a radiation-crosslinkable adhesive is used, the irradiation ought more particularly to take place with UV light, preferably at a wavelength in the range from 100 nm to 380 nm. 50-2000 J/cm² are suitable UV radiation doses. When the adhesive is irradiated with electron beams, a radiation dose of 10 to 100 kilograys (kGy) is preferred. In the case of the irradiation of the pressure-sensitive hot melt adhesive of the invention with UV light, crosslinking may be controlled not only by the radiation dose but also by the use of photoinitiators, photosensitizers or regulator molecules.

Following the application of a radiation-curing adhesive that is preferred in accordance with the invention, more particularly a hot melt adhesive, and following the assembly of the edges to be bonded, the adhesive of the invention is irradiated with a UV or electron beam dose sufficient for the adhesive briefly to possess sufficient adhesion and to join the surfaces. The duration of this irradiation ought to be below 10 sec, such as between 0.1 to 5 sec, for example. In the case of irradiation with UV rays it is preferred to use transparent labels or labels which at least at the bond seam are UV-transparent.

After the longitudinal edges have been bonded, the film tube is processed further. This may take place after storage or directly in one operation (in-line). In this case the tube, in a suitable length, is slit into sleeve labels. These sleeve labels are subsequently applied to the article that is to be labeled. In one embodiment they are elastically stretchable labels. In that case the sleeve is briefly stretched and, in the stretched state, is pushed over the article, such as bottles, aerosol cans or cuboidal packaging forms, for example. Thereafter the sleeve can contract again and is then fastened on the article. At this point the article to be labeled may be empty or may have already been filled. Machines for applying such labels to the articles are known to the skilled worker.

In one preferred embodiment the wrap-around label is a shrinkable sleeve. In this case the diameter of the sleeve is slightly larger than the article to be labeled. The label is brought over the article and immediately thereafter is exposed to a heat source, and so the shrinking operation is carried out. Generally speaking, the shrinkable sleeve labels are shrunk onto the contour within a few seconds at temperatures of at least 100° C., frequently over 120° C., usually over 150° C. The upper limit should be below 230° C. and the substrate or the contents of the body should not be damaged. In this case, where appropriate, the label can be briefly pressed on or is fixed by means of a point of adhesive so that it retains its correct position on the article. Following shrinkage, the label is seated fast on the article. The label may also match particular shapes of the article. Apparatus for the thermal shrinkage of sleeve labels, such as ovens, IR lamps, hot-air fans, is likewise known to the skilled worker.

In the region of the bond, following its application to the article, the sleeve label has a very low creep tendency in conjunction with high bond-seam adhesive strength. Where radiation-crosslinking hot melt adhesives are used, the thermal stability of the bond seam is significantly heightened.

The present invention likewise provides sleeve labels comprising shrinkable or stretchable single-layer or multilayer films which are bonded on one long side by a reactive adhesive. Such labels may be colorless, colored or printed. The labels may be produced individually by coating with adhesive and annular bonding; more particularly, however, a film tube is produced and, after bonding, is slit into the fitting sleeve labels.

The bond seam is preferably not printed on the bond area; in the case of radiation-crosslinking adhesives, the bonding site is transparent to the activating radiation. The bond seam ought generally to be bonded continuously over the length of the label; in exceptional cases, however, the adhesive may also be applied intermittently. The adhesive is applied in a width between 1 to 20 mm, more particularly between 2 to 10 mm. The layer thickness of the adhesive is thin and ought to be between 1 μm to 300 μm, more particularly between 3 μm to 150 μm.

The completed seam of adhesive ought to merge smoothly into the film and ought not to have any bead. The seam ought not to exhibit any thermal discoloration or any discoloration as a result of the applied adhesive.

Preferably the label of the invention can be produced immediately prior to its application to the article (in-line method). In that case the label is produced by bonding of a film in tube form, and this tube is cut up into fitting pieces and thereafter applied immediately to the article. In this case the bond seam within 5 min, preferably within 1 min, after the assembly of the bond seam has an adhesion which withstands the thermal load of shrinking or the recovery force in the case of stretching. The shear strength of the bond of the thermally unexposed film ought to be between 25 up to 250 N/12.5 mm. Under the application conditions of the label to the article, the label ought not to be destroyed at the bond seam; in other words, the bond seam ought not to open or the overlap ought not to slip.

The range of application of the labels of the invention is broad. They can be used as wrap-around labels. In that case they are suitable particularly for rotationally shaped articles, although other forms, more particularly contour bottles, may also be provided with the labels. Use as a label is also intended to include the use of shrinkable sleeve-shaped tube sections of this kind as a securement for closures of bottles, for example. It is also possible to package two or more articles together in one annular sleeve. The articles to be packed may contain different products, such as foods, beverages, medical products, cosmetics, and articles of everyday use.

Through the method of the invention it is possible to bring about stable fastening of sleeve labels on an article. Following their application, the labels of the invention do not display any defects or deformations at the bond seam. The bonding of the edges is sufficiently stable that the film tube can even be processed further in-line to form the labels, which can be applied immediately to the articles. This makes the production method substantially easier. Through the inventive use of reactive, hot melt adhesives, the use of solvent-containing adhesives is reduced or avoided entirely.

Dynamic Shear Test—Method:

In an instrument for the measurement of tensile strength, from the company Zwick, the tensile strength of the bond is measured at 25° C. and at a rate of advance of 5 mm/min. For this purpose, two films are bonded in a width of 10 mm; the test specimens are slit with a width of 12.5 mm and are measured transversely to the bond. A measurement is made of the force at which the adhesive bond fails.

### EXAMPLE

Test 1

Applied to one side of a printed, corona-pretreated OPP film which is transparent at the margin (ExxonMobil 50 LR 210) is a hot melt adhesive TECHNOPUR CB 2005-21 (isocyanate-crosslinking, PU, hot melt adhesive, application temperature 130° C., coat thickness 100 μm, width 1.0 cm) (Henkel KGaA). The edges of the film are overlapped and pressed together under pressure for 30 sec. Over the course of 3 min the tube is cut up into size-matched labels and a label is pushed onto a cleaned aluminum can (5 cm in diameter), and the overlap of the seam is marked. Subsequently the label is shrunk-on in a forced-air oven at 120° C. After that it is heated further at 120° C. After constant time intervals of 5 min at 120° C. an assessment is made of whether the bond seam withstands the shrinkage operation without alteration. After 15 min no slipping of the bond seam is observed.

Test 2

Applied to one side of a transparent OPP film (ExxonMobil 50 LR 210) is a hot melt adhesive TECHNOMELT 4105 (UV-crosslinking, melt-applied, PU, adhesive, application temperature 100° C., coat thickness 100 μm, width 1.0 cm) (Henkel KGaA). The edges of the film are overlapped and pressed together under pressure for 30 sec. The bond seam is subsequently irradiated using a UV lamp (Fusion F-600, 10 cm distance). After 2 min the tube is cut up into size-matched labels and pushed onto a cleaned aluminum can, and the overlap of the seam is marked. Subsequently shrinking takes place in a forced-air oven at 120° C. After time intervals of 5 min and with ongoing heating at 120° C. an assessment is made of whether the bond seam withstands the exposure without alteration. After 15 min no slipping of the bond seam is observed.

What is claimed is:

1. A method of continuously producing a film tube useful for producing a sleeve label for packaging, which comprises:
a) coating a single-layer or multilayer film which has two opposite longitudinal edges and is elastically stretchable or heat-shrinkable with a solvent-free adhesive at one longitudinal edge or on both opposite longitudinal edges on one side or on opposite sides of the film to form an adhesive layer;
b) thereafter bringing the two opposite longitudinal edges into overlap with one another and bonding the two opposite longitudinal edges to each other through the adhesive layer to produce a film tube capable of being further directly processed or processed after storage;
the adhesive being selected from adhesives which crosslink through actinic radiation or adhesives which crosslink through polycondensation of reactive groups.

2. The method as claimed in claim 1, wherein no primer is applied to the area to be bonded.

3. The method as claimed in claim 1, wherein the adhesive is a UV-crosslinking adhesive.

4. The method as claimed in claim 1, wherein the adhesive is a two-part adhesive crosslinking through reactive groups.

5. The method as claimed in claim 1, wherein the adhesive is a one-part adhesive crosslinking through temperature increase.

6. The method as claimed in claim 1, wherein the adhesive is a hot melt adhesive.

7. The method as claimed in claim 1, wherein, immediately after producing the film tube, the film tube is divided into sections and then affixed to a surface of an article to be labeled.

8. The method as claimed in claim 7, wherein the adhesive develops adhesion to the surface of the article within 3 minutes.

9. The method as claimed in claim 1, wherein the film tube is stored after being produced.

10. The method as claimed in claim 9, wherein the adhesive undergoes aftercure during storage.

11. The method as claimed in claim 1, wherein the film is a shrink-on film.

12. The method as claimed in claim 11, wherein the adhesive is applied and crosslinked at temperatures below the shrinking temperature of the film.

13. The method as claimed in claim 1, wherein the film is an elastically stretchable film.

14. The method as claimed in claim 1, wherein the film is pretreated and/or printed prior to bonding.

15. The method as claimed in claim 1, wherein the adhesive is a radiation-curing hot melt adhesive.

16. The method as claimed in claim 1, wherein the adhesive is a one part hot melt adhesive comprised of one or more reactive polyurethanes.

17. The method as claimed in claim 1, wherein the adhesive is a UV-crosslinking adhesive and the adhesive layer is subjected to irradiation with ultraviolet light.

18. The method as claimed in claim 1, wherein the adhesive layer has a thickness of between 3 μm to 150 μm.

19. A film tube or label prefabricated in sleeve form from elastically stretchable or heat-shrinkable film material with a longitudinal bond seam, produced by the method as claimed in claim 1.

20. The film tube or label prefabricated in sleeve form as claimed in claim 19, wherein the longitudinal bond seam has been produced with a solvent-free one-part hot melt adhesive crosslinking through actinic radiation or at elevated temperature.

21. The film tube or label prefabricated in sleeve form as claimed in claim 19, wherein the longitudinal bond seam has a tensile strength of greater than 25 N/12.5 mm, measured at 25° C. in the dynamic shear test.
